(19) United States
(12) Patent Application Publication
(10) Pub. No.: US 2009/0317144 A1
(43) Pub. Date: Dec. 24, 2009

(54) Image forming unit and image forming apparatus

(75) Inventor: Kenji Koido, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/453,916

(22) Filed: May 27, 2009

(30) Foreign Application Priority Data
Jun. 19, 2008 (JP) 2008-160662

(51) Int. Cl. G03G 15/08

(52) U.S. Cl. 399/284

(57) ABSTRACT

An image forming unit includes a developer bearing body that supplies a developer to an image bearing body that bears a latent image, and a developer layer forming member that forms a layer of the developer on the developer bearing body. The developer has a mean volume diameter in a range from 3.0 to 5.0 μm, and a bulk density in a range from 0.26 to 0.32 g/cm³. The developer layer forming member has a curved portion having a radius of curvature smaller than or equal to 0.18 mm and constituting a developer layer forming portion.

### BACKGROUND OF THE INVENTION

The present invention relates to an image forming apparatus such as a copier, a facsimile machine and a printer, and also relates to an image forming unit used in the image forming apparatus.

Japanese Laid-Open Patent Publication No. 2004-341122 discloses a conventional image forming apparatus including a developing roller (i.e., a developer bearing body) that causes a toner (i.e., a developer) to adhere to a latent image on a photosensitive drum (i.e., an image bearing body), and a toner layer forming member that forms a thin layer of the toner on the developing roller. The publication also discloses a saturation bulk density of the toner, an amount of the toner adhering to the developing roller, a surface potential of the toner, and an amount of the toner adhering to the photosensitive drum, so as to obtain a high quality image.

However, there is a demand for further enhancing image quality.

### SUMMARY OF THE INVENTION

The present invention is intended to provide an image forming unit and an image forming apparatus capable of enhancing image quality.

The present invention provides an image forming unit including a developer bearing body that supplies a developer to an image bearing body that bears a latent image, and a developer layer forming member that forms a layer of the developer on the developer bearing body. The developer has a mean volume diameter in a range from 3.0 to 5.0 μm, and a bulk density in a range from 0.26 to 0.32 g/cm³. The developer layer forming member has a curved portion having a radius of curvature smaller than or equal to 0.18 mm and constituting a developer layer forming portion.

With such an arrangement, image quality can be enhanced.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a side view schematically showing a configuration of an image forming apparatus employing an image forming unit according to the embodiments of the present invention;

FIG. 2 is a schematic view showing the image forming unit;

FIG. 3 is a schematic view showing an arrangement of the image forming unit as well as a transfer belt, a transfer roller and an LED head;

FIG. 4 is a schematic view showing a developer cartridge of the image forming unit;

FIG. 5 shows characteristics of toners used in printing tests;

FIG. 6 is a schematic view for illustrating a curved portion of a developing blade of the image forming unit, particularly showing a radius R of curvature thereof;

FIG. 7 is a schematic view for illustrating the curved portion of the developing blade of the image forming unit, particularly showing a bent angle D thereof;

FIG. 8 is a plan views showing image concentration measurement positions on a printing medium;

FIG. 9 is a plan view showing fog observing positions on the printing medium;

FIG. 10 shows conditions and results of Examples 1-1 to 1-9 and Comparisons 1-1 to 1-11;

FIG. 11 shows conditions and results of Examples 1-10 to 1-18 and Comparisons 1-12 to 1-22;

FIG. 12 shows conditions and results of Examples 1-19 to 1-27 and Comparisons 1-23 to 1-33;

FIG. 13 shows conditions and results of Comparisons 1-34 to 1-53;

FIG. 14 shows conditions and results of Comparisons 1-54 to 1-73;

FIG. 15 shows characteristics of developing blades used in the printing tests, and

FIG. 16 shows conditions and results of Examples 2-1 to 2-8 and Comparisons 2-1 to 2-4.

### DETAILED DESCRIPTION OF THE PREFERRED EMBODIMENT

Hereinafter, embodiments and examples of the present invention will be described with reference to the attached drawings. In this regard, the present invention is not limited to the embodiments, but can be modified without departing from the scope of the invention.

### First Embodiment

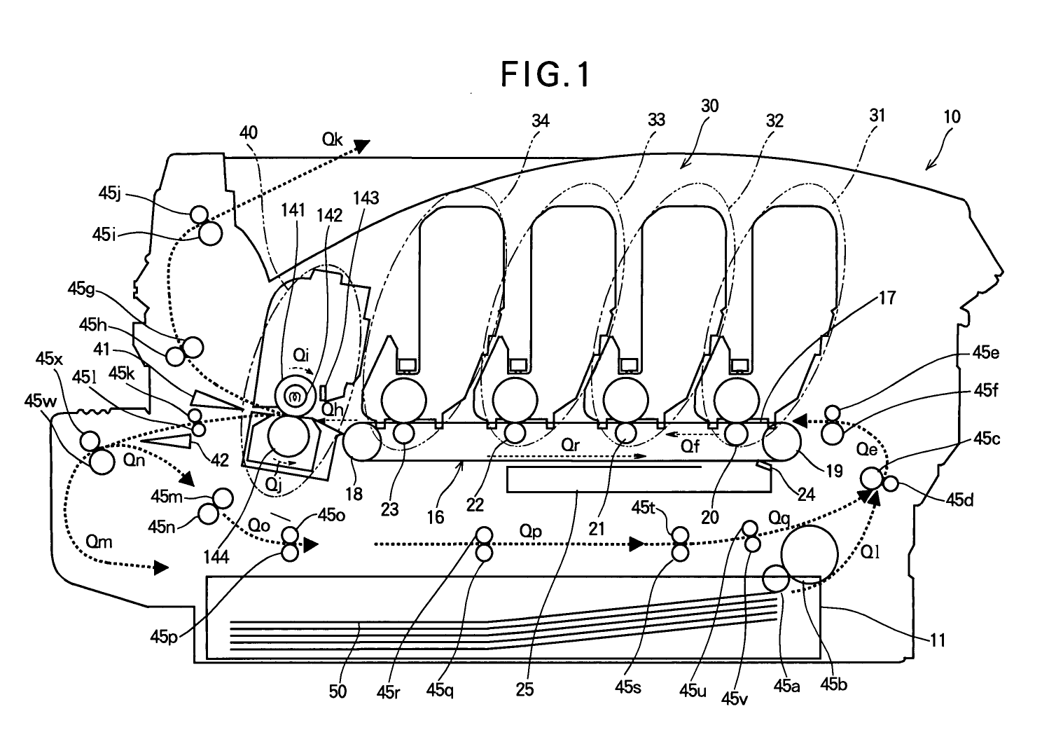

FIG. 1 is a side view schematically showing a printer as an image forming apparatus according to the first embodiment of the present invention.

The printer 10 is configured as a color electrophotographic printer, and includes a printing medium cassette 11, image forming units 31, 32, 33 and 34, a transfer portion 16 and a fixing portion 40. Further, the printer 10 includes feeding rollers 45a through 45x and feeding path switching guides 41 and 42 for feeding a printing medium 50 through the image forming units 31, 32, 33 and 34, the transfer portion 16 and the fixing portion 40.

The printing medium cassette 11, in which a stack of the printing media 50 is stored, is detachably mounted to a lower part of the printer 10. The feeding rollers 45a and 45b pickup the uppermost printing medium 50 of the stack stored in the printing medium cassette 11, and feed the printing medium 50 along the feeding path in a direction shown by arrow Ql in FIG. 1. The feeding rollers 45c and 45d and the feeding rollers 45e and 45f feed the printing medium 50 toward the image forming units 31, 32, 33 and 34 in a direction shown by arrow Qe in FIG. 1 while correcting skew of the printing medium 50.

The image forming units 31, 32, 33 and 34 (i.e., an image forming portion 30) are detachably mounted to a main body of the printer 10 and are linearly arranged along the feeding path. The image forming units 31, 32, 33 and 34 form developer images of respective colors which are transferred to the printing medium 50 by the transfer portion 16 described below. The image forming units 31, 32, 33 and 34 have the same configurations except the developers (for example, colors of developers). As an example, the image forming units 31, 32, 33 and 34 respectively use developers of black (K), yellow (Y), magenta (M) and cyan (C).

The transfer portion 16 is configured to transfer developer images formed on image bearing bodies of the image forming units 31, 32, 33 and 34 to the printing medium 50 by means of Coulomb force. The transfer portion 16 includes a transfer belt 17 that electrostatically absorbs and feeds the printing medium 50, a driving roller 18 rotated by a driving unit (not shown) to drive the transfer belt 17, and a tensioning roller 19 paired with the driving roller 18 to apply tension to the transfer belt 17. The transfer portion 16 further includes transfer rollers 20, 21, 22 and 23 disposed facing photosensitive drums 101 (described later) of the image forming units 31, 32, 33 and 34 and pressed against the photosensitive drums 101. The transfer rollers 20, 21, 22 and 23 are applied with voltages so as to transfer the developer images to the printing medium 50. The transfer portion 16 further includes a transfer belt cleaning blade 24 that cleans the transfer belt 17 by scraping off the developer from the transfer belt 17, and a waste developer tank 25 that stores the developer scraped off by the transfer belt cleaning blade 24.

Here, a configuration of the image forming unit 31 using the developer of black (K) will be described. The image forming unit 32 using the developer of yellow (Y), the image forming unit 33 using the developer of magenta (M) and the image forming unit 34 using the developer of cyan (C) have the same configurations as the image forming unit 31 except the colors of the developers, and therefore explanations thereof will be omitted.

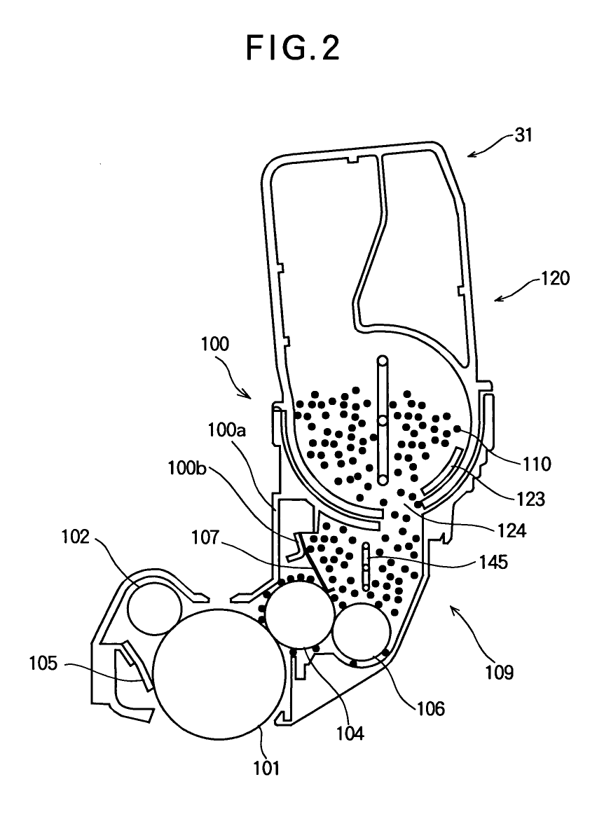

FIG. 2 is a sectional view schematically showing the configuration of the image forming unit 31. As shown in FIG. 2, the image forming unit 31 includes a developing device 109 including a developing portion 100 and a developer storing body 120. The developing portion 100 includes a developing roller 104 as a developer bearing body, a supplying roller 106, and a developing blade 107 as a developer layer forming member 107. The image forming unit 31 further includes a photosensitive drum 101 as an image bearing body, a charging roller 102 as a charging member, and a cleaning blade 105.

The image forming unit 31 is detachably mounted to a predetermined position in the image forming portion 30. The developer storing body 120 is detachably mounted to the developing portion 100.

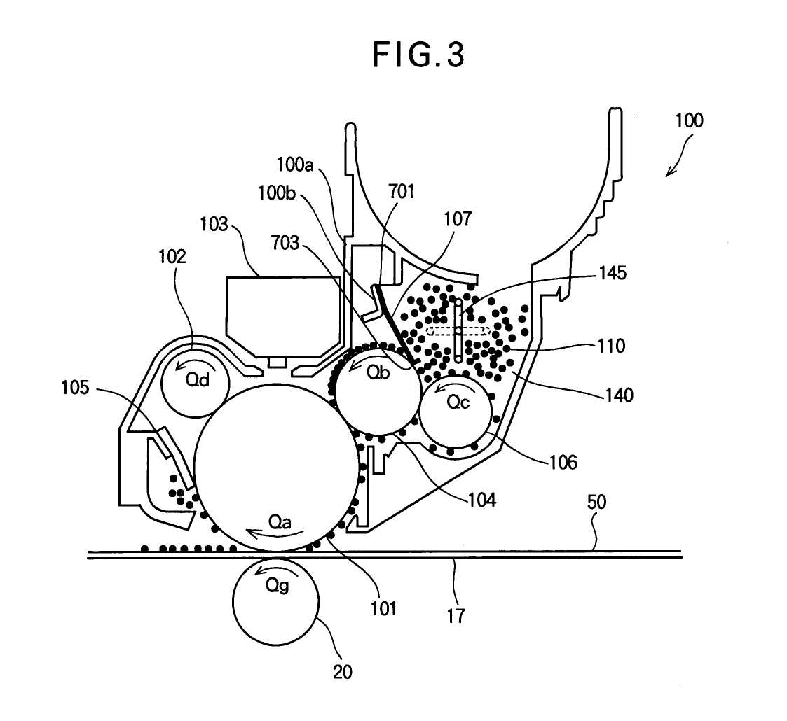

FIG. 3 is a sectional view schematically showing the image forming unit 31 except the developer storing body 120. As shown in FIG. 3, the photosensitive drum 101 (i.e., the image bearing body) includes an electrically-conductive supporting body and a photoconductive layer. To be more specific, the photosensitive drum 101 is, for example, an organic photosensitive body composed of a metal pipe of aluminum (as the electrically-conductive supporting body) with a charge generation layer and a charge transport layer (as the photoconductive layer) laminated thereon.

In this regard, the photosensitive drum 101 can be an inorganic photosensitive body composed of an electrically-conductive supporting roller of aluminum or the like with a photoconductive layer of selenium, amorphous silicon or the like formed thereon, or. The photosensitive drum 101 can be an organic photosensitive body having an organic photoconductive layer containing binder resin in which charge generation agent and charge transport agent are dispersed. The photosensitive drum 101 rotates in a direction shown by arrow Qa in FIG. 3. The transfer roller 20 disposed facing the photosensitive drum 101 via the transfer belt 17 and the printing medium 50 rotates in a direction shown by arrow Qg in FIG. 3.

The charging roller 102 (i.e., the charging device) is disposed contacting a circumferential surface of the photosensitive drum 101, and is composed of a metal shaft with a semiconductive epichlorohydrin rubber layer formed thereon. The charging roller 102 rotates in a direction shown by arrow Qd.

An LED (Light Emitting Diode) head 103 as an exposing device (i.e., a latent image forming device) includes, for example, an LED element and a lens array. The LED head 103 is disposed so that light emitted by the LED element is focused on the surface of the photosensitive drum 101.

The developing roller 104 (i.e., the developer bearing body) is disposed contacting the circumferential surface of the photosensitive drum 101, and is composed of a metal shaft with a semiconductive urethane rubber layer formed thereon. It is possible to use, for example, a material used for a general developing roller, which includes an electrically-conductive supporting shaft of stainless steel or the like with a layer of silicone rubber, urethane rubber or the like formed thereon. An electric resistance of the layer of silicone rubber, urethane rubber or the like is adjusted by adding carbon or the like. The developing roller 104 rotates in a direction shown by arrow Qb,

The supplying roller 106 (i.e., a developer supplying body) is disposed slidably contacting the developing roller 104. The supplying roller 106 includes a metal shaft with a semiconductive foamed silicone sponge layer formed thereon. The supplying roller 106 rotates in a direction shown by arrow Qc.

The developing blade 107 (i.e., the developer layer forming member) is pressed against the surface of the developing roller 104. The developing blade 107 can be composed of a material used for a general developing blade, for example, a metal such as stainless steel or a rubber such as silicone rubber. The developing blade 107 can be applied with a voltage as necessary.

The cleaning blade 105 (i.e., a developer recovery device) is composed of urethane rubber, and is pressed against the circumferential surface of the photosensitive drum 101.

A toner hopper 140 (i.e., a developer reserving portion) is provided in the developing portion 100 for reserving the developer (denoted by numeral 110 in FIG. 3) supplied from the developer storing body 120. An agitation shaft 145 (i.e., an agitating member) is disposed in the toner hopper 140. The agitation shaft 145 is rotated by a driving force transmitted via a gear of the supplying roller 106, and agitates the developer 110 in the toner hopper 140 to thereby prevent agglomeration of the developer 110. As a printing operation proceeds, the developer 110 in the toner hopper 140 is supplied to the developing roller 104 via the supplying roller 106.

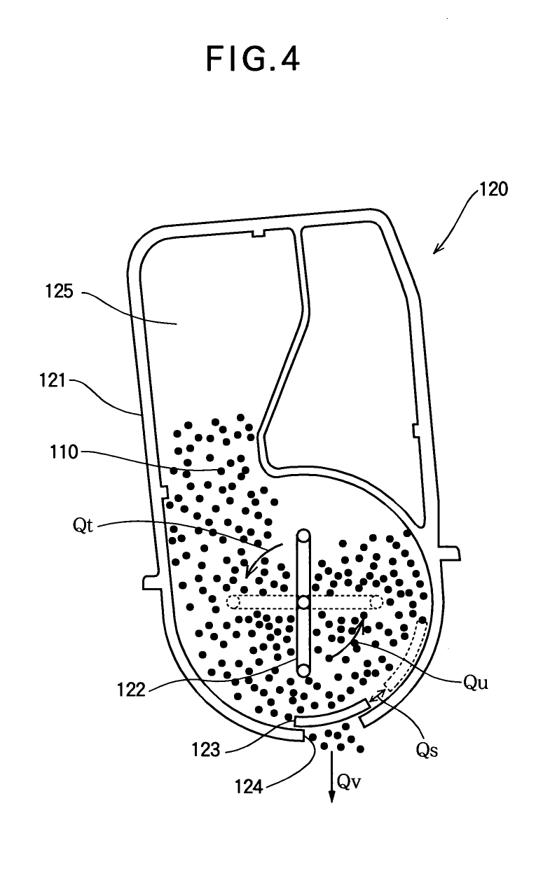

FIG. 4 is a sectional view schematically showing an internal configuration of the developer storing body 120. As shown in FIG. 4, a container 121 of the developer storing body 120 includes a developer storing portion 125. An agitation bar 122 is disposed in the developer storing portion 125. The agitation bar 122 extends in a longitudinal direction of the developer strong portion 125 (i.e., in a direction perpendicular to the sheet of FIG. 4), and is supported so as to be rotatable in directions shown by arrows Qt and Qu. An outlet opening 124 is formed on the container 121 below the agitation bar 122, through which the developer 110 in the container 121 is ejected. A shutter 123 is disposed inside the container 121 so as to be slidable in directions shown by arrow Qs to open and close the outlet opening 124.

The printing medium 50 to which the developer images of respective colors have been transferred by the image forming portion 30 is fed along the feeding path in a direction shown by arrow Qh in FIG. 1 to reach the fixing portion 40 as described later. As shown in FIG. 1, the fixing portion 40 includes a heat roller 141, a pressure roller 144, a heater 142 and a thermistor 143. The heat roller 141 includes a hollow metal core of aluminum, a heat-resisting resilient layer of silicon rubber covering the hollow metal core, and a tube of PFA (tetra fluoro ethylene-perfluoro alkylvinyl ether copolymer) covering the heat-resisting resilient layer. Further, the heater 142 such as a halogen lamp is disposed in the hollow metal core.

The thermistor 143 is a surface temperature detecting unit for the heat roller 141, and is disposed in the vicinity of the heat roller 141 in a non-contact manner. Temperature information detected by the thermistor 143 is sent to a temperature control unit (not shown). The temperature control unit performs ON/OFF control of the heater 142 based on the temperature information, so as to maintain the surface temperature of the heat roller 141 to a predetermined temperature.

The pressure roller 144 includes a metal core of aluminum, a heat-resisting resilient layer covering the metal core, and a tube of PFA covering the heat-resisting resilient layer. The pressure roller 144 is pressed against the heat roller 141 to form a nip portion therebetween.

The cleaning blade 105 and the transfer belt cleaning blade 24 are composed of resilient body such as urethane rubber, epoxy rubber, acrylic rubber, fluorine resin rubber, nitrile butadiene rubber (NBR), styrene butadiene rubber (SBR), isoprene rubber (IR), polybutadiene rubber or the like.

Next, a description will be made of the developer. The developer is stored in the developer storing body 120 of the image forming unit of the printer 10 (i.e., the image forming apparatus) according to the first embodiment of the present invention.

The developer according to the first embodiment of the present invention includes toner mother particles (containing at least binder resin) added with external additives such as inorganic fine powder. Such a developer is referred to as a toner. The binder resin is not specifically limited, but it is preferable to use polyester resin, styrene acryl resin, epoxy resin or styrene butadiene resin.

Further, the binder resin can be added with releasing agent, coloring agent or the like. Further, the binder resin can be added with charge control agent, electrical-conductivity adjusting agent, extender pigment, reinforcing filler such as fibrous substance, aging prevention agent, fluidity enhancing agent, cleaning performance enhancing agent or the like as necessary.

The releasing agent is not specifically limited, but it is preferable to use known releasing agent such as low-molecular weight polyethylene, low-molecular weight polypropylene, olefin copolymer, microcrystalline wax, paraffin wax, fatty series hydrocarbon such as Fischer-Tropsch wax, oxide of fatty series hydrocarbon such as oxide polyethylene wax, block copolymer of these materials, carnauba wax, wax composed primarily of fatty acid ester (such as montanic acid ester wax), partially or wholly deoxidized fatty acid ester such as deoxidized carnauba wax.

It is advantageous that the releasing agent in a range from 0.1 to 20 weight parts is added to the binder resin of 100 weight parts. It is more preferable that the releasing agent in a range from 0.5 to 12 weight parts is added to the binder resin of 100 weight parts. It is also preferable to use a plurality of waxes.

The coloring agent is not specifically limited, but it is possible to use dye, pigment or the like used as coloring agent of general black, yellow, magenta and cyan toner, alone or in combination. For example, it is possible to use carbon black, iron oxide, phthalocyanine blue, permanent brown FG, brilliant fast scarlet, pigment green B, rhodamine-B base, solvent red 49, solvent red 146, pigment blue 15:3, solvent blue 35, quinacridone, carmine 6B, disazo yellow or the like. The coloring agent in a range from 2 to 25 weight parts is added to the binder resin of 100 weight parts. It is more preferable that the coloring agent in a range from 2 to 15 weight parts is added to the binder resin of 100 weight parts.

It is possible to use known charge control agent. For example, quaternary ammonium salt charge control agent can be used for a positively chargeable toner, and azo complex charge control agent, salicylic acid charge control agent or calixarene charge control agent can be used for a negatively chargeable toner.

The external additives are added for the purpose of enhancing environmental stability, charge stability, developing performance, fluidity and preserving property. Known external additives such as inorganic fine powder (for example, silica fine powder) can be used.

The toner according to the first embodiment of the present invention can be manufactured using known method such as pulverization and polymerization.

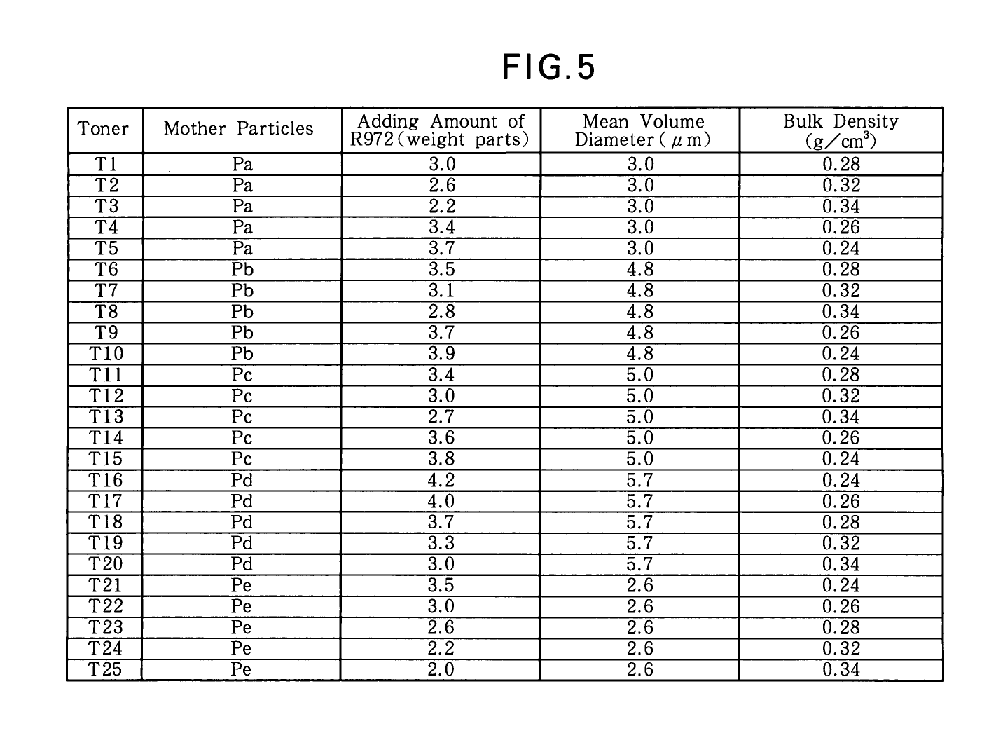

Next, Examples of the first embodiment of the present invention will be described. First, toners used in printing tests will be described with reference to FIG. 5.

### <Manufacturing Method of Toner T1>

The following materials were mixed in a Henschel mixer: 100 weight parts of binder resin (polyester resin, number average molecular weight Mn=3700, glass transition temperature Tg=62° C., softening temperature T_{1/2}=115° C.), 0.5 weight parts of charge control agent “T-77” (manufactured by Hodogaya Chemical Co., Ltd.), 5.0 weight parts of pigment blue 15:3 (“ECB-301” manufactured by DainichiSeika manufacturing Co., Ltd.) as coloring agent, and 4.0 weight parts of carnauba wax (“Powdered Carnauba Wax No. 1” manufactured by S. Kato and Co.) as releasing agent. The resultant material was molten and kneaded using a twin-screw extruder. The resultant material was cooled, and cracked using a cutter mill whose screen size is 2 mm. Then, the resultant material is crushed using a crusher with an impact plate (“Dispersion Separator” manufactured by Nippon Pneumatic Manufacturing Co., Ltd.). Further, the resultant material was classified using an air classifier, so that toner mother particles Pa were obtained. Next, as shown in FIG. 5, 3.0 weight parts of hydrophobic silica R972 (manufactured by Nippon Aerosil Ltd., a primary mean diameter is 16 nm) as external additives was added to 1 kg (100 weight parts) of the toner mother particles Pa. The resultant material was agitated in the Henschel mixer for three minutes. The toner obtained using this process is referred to as a toner T1.

The mean volume diameter (μm) of the toner was measured using a cell counter/analyzer (“Coulter Multisizer III” manufactured by Beckman Coulter Inc.). An aperture diameter of the cell counter/analyzer was set to 100 μm, and the number of measured particles was set to 30000. As a result of measurement, the mean volume diameter of the toner T1 was 3.0 (μm).

A bulk density (apparent density), more specifically, a loose bulk density of the toner was measured as follows.

A multifunctional powder characteristics measuring equipment “Multi Tester MT-1001” (manufactured by Seishin Enterprise Co., Ltd.) was used. The toner was caused to fall through a sieve into a cell container of 20 cc on the measuring equipment while applying a vibration with amplitude of 1 mm. The sieve has a mesh size of 250 μm and a diameter of 75 mm. Then, the toner filling the cell container was leveled off using a paddle having a straight edge, and a weight of the toner in the cell container was measured. Then, the bulk density (g/cm³) was obtained using the following equation:

The bulk density (g/cm³)=the weight of the toner in the cell container (g)/the capacity of the cell container (cm³)

As a result of measurement, the bulk density of the toner T1 was 0.28 g/cm³.

### <Manufacturing Method of Toner T2>

As shown in FIG. 5, 2.6 weight parts of hydrophobic silica R972 (manufactured by Nippon Aerosil Ltd., a primary mean diameter is 16 nm) as external additives was added to 1 kg (100 weight parts) of the toner mother particles Pa. The resultant material was agitated in the Henschel mixer for three minutes. The toner obtained using this process was referred to as a toner T2. As a result of measurement, the mean volume diameter of the toner T2 is 3.0 μm, and the bulk density of the toner T2 was 0.32 g/cm³. In this example, the bulk density was varied by varying the adding amount of the external additives. However, the bulk density can be varied using other method.

### <Manufacturing Method of Toners T3 to T25>

Similarly, toners T3 to T5 were manufactured by varying the adding amount of the external additives as shown in FIG. 5. Further, toners T6 to T25 were manufactured using toner mother particles Pb, Pc, Pd and Pe having different diameters (obtained by varying classification conditions) and by varying the adding amount of the external additives as shown in FIG. 5. The mean volume diameters and the apparent densities of the toners T3 though T25 are also shown in FIG. 5.

### <Measuring Method of Circularity of Toner>

A circularity of the toner is measured using “Flow Particle Image Analyzer FPIA 2100” manufactured by Sysmex Corporation according to the following equation:

Circularity=L1/L2

where L1 represents the circumference of a circle having the same area as a projected image of the particle (i.e., the toner), and L2 represents a perimeter of the projected image of the particle. If the circularity is 1, the form of the particle is true sphere. As the circularity becomes smaller, the form of the particle becomes indefinite. In using the flow particle image analyzer, the number of particles to be measured was set to 2000. The toner was dispersed in a dispersion medium so that particle concentration is in a range from 1000 to 7000 pieces/μl.

In Examples described later, a toner (to be more specific, a pulverized toner) having the circularity in a range from 0.930 to 0.955 was used as the developer.

### <Operation of Printer>

Next, an operation of the above configured printer 10 will be described.

As shown in FIG. 3, the photosensitive drum 101 is rotated by a driving unit (not shown) at a constant circumferential speed in the direction shown by arrow Qa in FIG. 3. The charging roller 102 rotates in the direction shown by arrow Qd in FIG. 3 contacting the surface of the photosensitive drum 101 and applies direct voltage (supplied by a not shown charging roller high voltage power source) to the surface of the photosensitive drum 101, so as to uniformly charge the surface of the photosensitive drum 101. Next, the LED head 103 irradiates the surface of photosensitive drum 101 with light according to image signal. An electric potential of the irradiated part of the surface of the photosensitive drum 101 attenuates, so that a latent image is formed on the surface of the photosensitive drum 101.

In a state where the developer storing body 120 is mounted on the developing portion 100 as shown in FIG. 2, the shutter 123 of the developer storing body 120 is slid in a direction shown by arrow Qs (FIG. 4) for opening the outlet opening 124 of the container 121 by the operation of a not shown lever. As the outlet opening 124 is opened, the developer 110 in the container 121 falls in the direction shown by arrow Qv in FIG. 4 through the outlet opening 124, and is supplied to the toner hopper 140 (the developer reserving portion) of the developing portion 100. In the toner hopper 140, the developer 110 is agitated by the agitation shaft 145, and is supplied to developing roller 104 via the supplying roller 106. The circumferential speed of the agitation shaft 145 is preferably in a range from 150 to 300 mm/sec. In Examples described later, the circumferential speed of the agitation shaft 145 is set to 200 mm/sec.

The developing roller 104 is disposed tightly contacting the photosensitive drum 101, and is applied with a voltage by a developing roller high voltage power source (not shown). The developing roller 104 absorbs the developer 110 carried by the supplying roller 106, and rotates to carry the developer 110 in the direction shown by arrow Qb in FIG. 4. The developing blade 107 contacting the developing roller 104 at a position on the downstream side of the supplying roller 106 forms the developer 110 on the developing roller 104 into a developer layer having a uniform thickness.

The developing roller 104 reversely develops the latent image on the photosensitive drum 101 using the developer 110 on the developing roller 104. A bias voltage is applied between a conductive supporting body of the photosensitive drum 101 and the developing roller 104 by a high voltage power source, and therefore lines of electric force are generated between the developing roller 104 and the photosensitive drum 101 due to the latent image on the photosensitive drum 101. Therefore, the charged developer 110 on the developing roller 104 adheres to the latent image on the photosensitive drum 101 by means of electrostatic force, so as to develop the latent image, i.e., to form a developer image. This developing process (beginning with rotation of the photosensitive drum 101) is started at a predetermined timing described later.

The printing medium 50 stored in the printing medium cassette 11 as shown in FIG. 1 is fed one by one out of the printing medium cassette 11 by the feeding rollers 45a and 45b in the direction shown by arrow Ql in FIG. 1. Then, the printing medium 50 is fed by the feeding rollers 45c and 45d and the feeding rollers 45e and 45f in the direction shown by arrow Qe in FIG. 1 while the skew of the printing medium 50 is corrected. The printing medium 50 is further fed by the transfer belt 17 that rotates in the direction shown by arrow Qf in FIG. 1. In this regard, the above described developing process starts in each image forming units at a predetermined timing while the printing medium 50 is being fed in the direction shown by arrow Qe.

As shown in FIG. 3, the transfer roller 20 is disposed facing and pressed against the photosensitive drum 101 of the developing portion 100 of the image forming unit 31 of black (K), and is applied with a voltage by a transfer roller high voltage power source (not shown). The transfer roller 20 transfers a black developer image on the photosensitive drum 101 to the printing medium 50 which electrostatically adheres to and is fed by the transfer belt 17. This process is referred to as a transfer process.

Then, the printing medium 50 proceeds in the direction shown by arrow Qf in FIG. 1 by the transfer belt 17. Using the same developing process and the transfer process as those performed by the image forming unit 31 and the transfer roller 20, a yellow developer image is transferred to the printing medium 50 by the image forming unit 32 and the transfer roller 21, a magenta developer image is transferred to the printing medium 50 by the image forming unit 33 and the transfer roller 22, and a cyan developer image is transferred to the printing medium 50 by the image forming unit 34 and the transfer roller 23. The printing medium 50 with developer images being transferred is fed in the direction shown by arrow Qh in FIG. 1.

The printing medium 50 to which at least one developer image of at least one color is transferred is fed in the direction shown by arrow Qh in FIG. 1, to reach the fixing portion 40. The printing medium 50 is fed into between the heat roller 141 and the pressure roller 144. The heat roller 141 rotates in the direction shown by arrow Qi in FIG. 1, and the temperature of the heat roller 141 is controlled by the temperature control unit (not shown) to a predetermined temperature. The pressure roller 144 rotates in the direction shown by arrow Qj. The heat roller 141 applies heat to the developer image to cause the developer image to be molten. The heat roller 141 and the pressure roller 144 apply pressure to the molten developer image so as to fix the developer image to the printing medium 50.

The printing medium 50 to which the developer image is fixed is fed in the direction shown by arrow Qk by the feeding rollers 45g and 45h and the feeding rollers 45i and 45j, and is ejected out of the printer 10.

A slight amount of the developer 110 may remain on the surface of the photosensitive drum 101 after the transfer process. The residual developer 110 is removed by the cleaning blade 105 (FIGS. 2 and 3). The cleaning blade 105 is disposed in parallel to a rotation axis of the photosensitive drum 101. A root portion of the cleaning blade 105 is fixed to a rigid supporting plate so that a tip of the cleaning blade 105 contacts the surface of the photosensitive drum 101. The residual developer 110 on the surface of the photosensitive drum 101 is removed by the cleaning blade 105 as the photosensitive drum 101 rotates about a rotation axis in a state where the cleaning blade 105 contacts the circumferential surface of the photosensitive drum 101. The photosensitive drum 101 from which the residual developer 101 is removed is repeatedly used.

In a period after the printing is performed on the printing medium 50 and before the next printing is performed on the next printing medium 50 during a continuous printing operation, there are cases where a part of developer 110 which is insufficiently charged may be transferred to the transfer belt 17 from the photosensitive drums 101 of the image forming units 31, 32, 33 and 34. Such a developer 110 is removed from the transfer belt 17 by the transfer belt cleaning blade 24 and is stored in the waste developer tank 25 when the transfer belt 17 rotates in the direction shown by arrows Qf and Qr in FIG. 1. The transfer belt 17 from which the developer 110 is removed is repeatedly used.

In a double-sided printing operation (i.e., when printing is to be performed on both sides of the printing medium 50), the feeding path switching guides 41 and 42 switch the feeding path. In this case, the printing medium 50 (with the developer image being fixed) is fed in the direction shown by arrow Qm by the feeding rollers 45k and 45l and the feeding rollers 45w and 45x, and then the printing medium 50 is fed in the direction shown by arrow Qn by the feeding rollers 45w and 45x, so that the printing medium 50 is inverted. Then, the printing medium 50 is fed in the direction shown by arrows Qo, Qp and Qq by the feeding rollers 45m through 45v. Then, the printing medium 50 is fed in the direction shown by arrow Qe by the feeding rollers 45c and 45d, and the printing is performed on a backside of the printing medium 50 (i.e., opposite to a side to which the developer image has been fixed).

### EXAMPLE 1-1

The following printing test was performed using the image forming apparatus (i.e., the printer 10) shown in FIG. 1. The image forming unit 31 shown in FIG. 1 was caused to operate using the toner T1. The other image forming units 32, 33 and 34 were not caused to operate. The toner T1 of 400 g was supplied to the developer cartridge (i.e., the developer storing portion 120) shown in FIG. 4, and the developer cartridge was mounted to the image forming unit 31 as shown in FIG. 2.

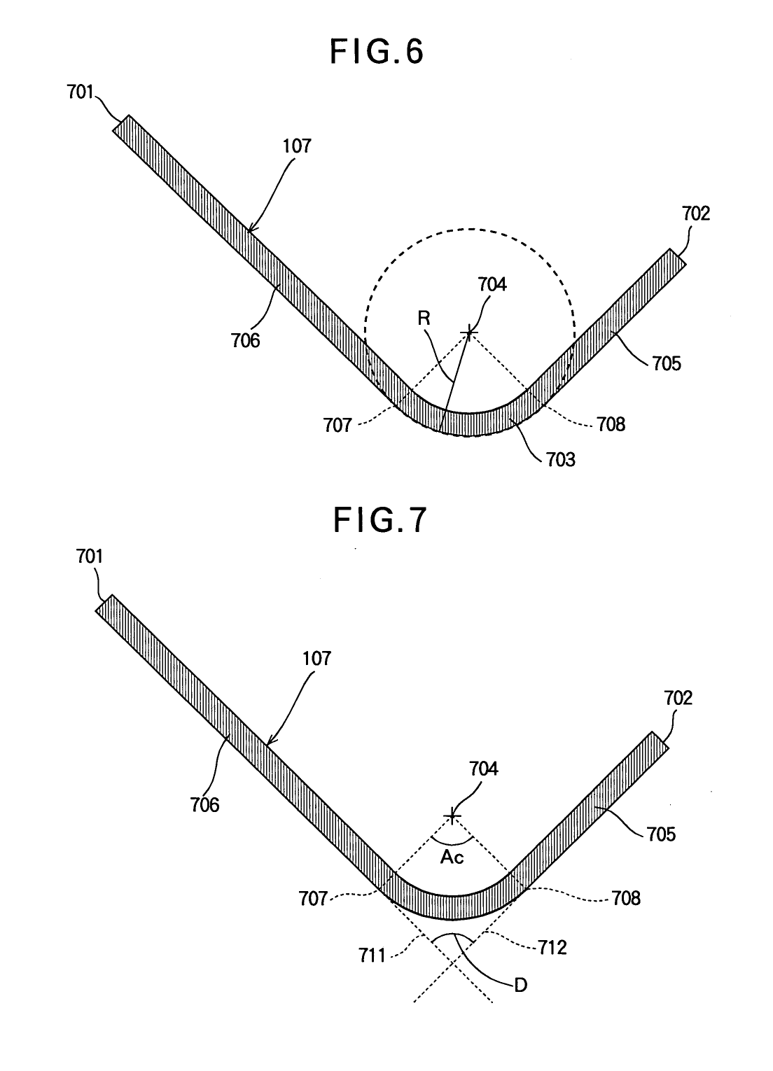

The developing blade 107 in the image forming unit 31 was formed of, for example, an elongated rectangular thin plate. The developing blade 107 was disposed in such a manner that the longitudinal direction of the developing blade 107 was parallel to the axial direction of the developing roller 104. A root portion in the vicinity of a longer edge 701 of the developing blade 107 was fixed to a part 100b of a frame 100a of the developing portion 100. The thickness of the developing blade 107 was 0.08 mm. A portion in the vicinity of the other longer edge 702 of the developing blade 107 was bent as shown in FIGS. 6 and 7 to form a curved portion 703. The curved portion 703 formed a part of a cylindrical surface of a cylinder having an axis parallel to the center axis of the developing roller 104. A part 705 of the developing blade 107 between the curved portion 703 and the edge 702 was flat, and a part 706 of the developing blade 107 between the curved portion 703 and the edge 701 was flat. The curved portion 703 was pressed against the surface of the developing roller 104 at an outer circumferential surface of the curved portion 703. A pressure (i.e., a linear pressure) for pressing the curved portion 703 against the developing roller 104 per unit length was, for example, 3.6 g/mm.

A radius of curvature of the curved portion 703 is expressed as R. An angle (i.e., bent angle) between the parts 705 and 706 is expressed as D. As shown in FIG. 7, the bent angle D is defined as an angle between a tangential plane 711 (aligned with an outer surface of the part 706) of an outer curved surface (i.e., an outer surface on a side contacting the developing roller 104) at one end 707 of the curved portion 703 and a tangential plane 712 (aligned with an outer surface of the part 705) of the outer curved surface at the other end 708 of the curved portion 703. The bent angle D (°) is determined by the following equation:

D=180−Ac(°)

where Ac represents a center angle of the curved portion 703 as shown in FIG. 7. The radius R of curvature and the bent angle D were measured as follows:

A surface roughness measuring instrument “Surfcoder SE 3500” (manufactured by Kosaka Laboratory Ltd. with a drive unit “DR-100×62”) was used. In using the surface roughness measuring instrument, a radius of stylus was set to 25 μm, a scanning speed was set to 0.02 mm/s and a measuring magnification was set to 200 (XY). Under these measuring conditions, the curved surface of the developing blade 107 was scanned by the measuring instrument, and image data was inputted into a personal computer. As a result of measurement, the radius R of curvature of the curved portion 703 of the developing blade 107 was 0.13 mm, and the bent angle D was 90°. In Example 1-1 and subsequent Examples (and Comparisons) of the first embodiment, the developing blade 107 having the bent angle D of 90° is used while varying the radius R of curvature thereof.

A standard paper of A4 size (to be more specific, “Oki Excellent White paper” whose paper weight is 80 g/m²) was used as the printing medium 50. The printing medium 50 (i.e., paper) was set in the printer 10 in such a manner that a backside of the paper (i.e., a side facing down when a package of papers was unwrapped) became a printing surface. The printing medium 50 was longitudinally fed. In other words, two shorter edges of the printing medium 50 respectively became a leading end and a tail end in the feeding direction. The surface temperature of the heat roller 141 of the fixing portion 40 was set to 175° C. The feeding speed of the recording medium 50 was set to 250 mm/s. A printing was performed on 5000 recording media 50, using a test pattern with a printing density of 100% and with a printing area ratio (i.e., a ratio of a printed area to a printable area) of 5%. The temperature was set to 23° C. and humidity was set to 40%. The papers (i.e., printing media 50), the toner and the printer 10 were left in this test environment for sufficient time.

After the printing was performed on 5000 printing media 50, a whole-area (i.e., with a printing area ratio of 100%) halftone image with a printing density of 25% was printed on one printing medium 50 of A4 size, a whole-area solid image with a printing density of 100% was printed on another printing medium 50 of A4 size, and then a test pattern with a printing density of 100% and with a printing area ratio of 5% was printed on still another printing medium 50 of A4 size, with the result that a printing sample was obtained.

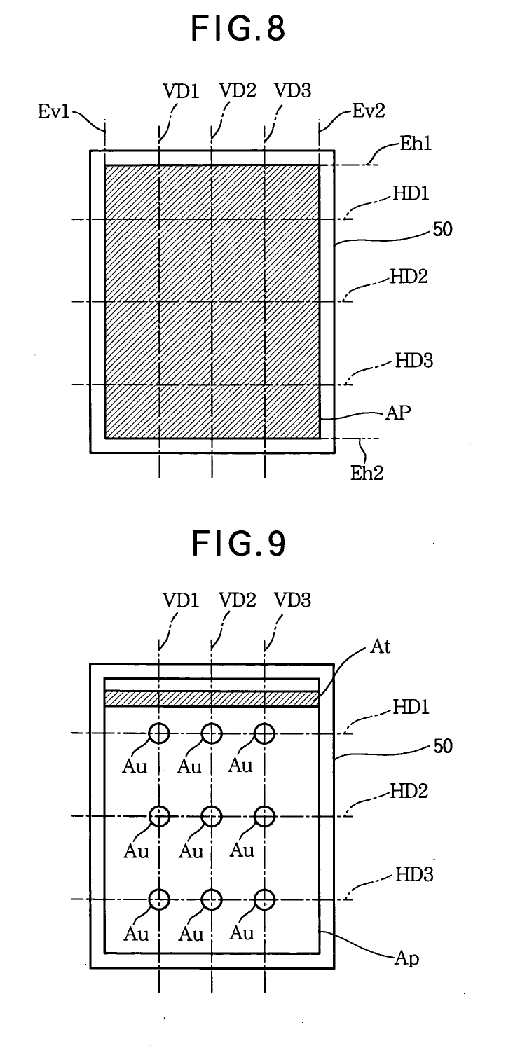

Using this printing sample, an image concentration was measured, and solid-image-blurring and fog were checked. The image concentration was measured at 9 measurement positions in an area with the printing density of 100% as shown by hatching in FIG. 8 (i.e., a whole printable area Ap) of the printing sample using a concentration meter “X-Rite 528” (manufactured by X-rite Corp.). The measured values were averaged so as to give the image concentration. These 9 measurement positions were the same as fog observing positions As (FIG. 9) as described later.

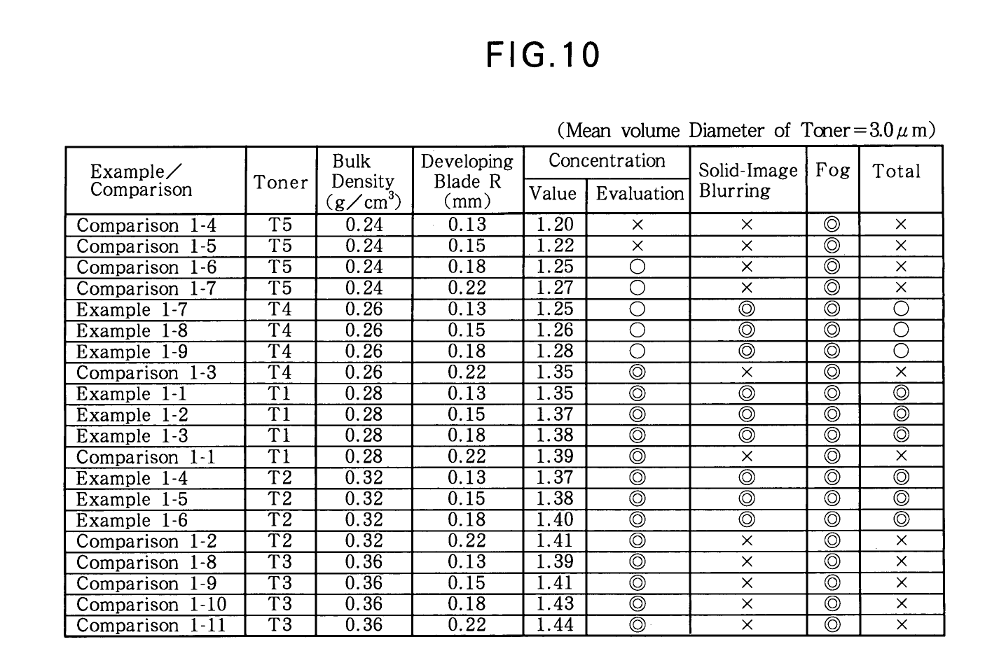

When the image concentration is lower than 1.25, a full color image lacks sharpness and looks pale, so as not to create a deep impression. In contrast, when the image concentration is higher than or equal to 1.25, a sufficient image can be obtained. Particularly, when the image concentration is higher than or equal to 1.35, a sharp full color image such as a photographic image can be obtained. In FIGS. 10 to 14, the evaluation result “⊚” (i.e., excellent) indicates that the image concentration was higher than or equal to 1.35. The evaluation result “O” (i.e., good) indicates that the image concentration is higher than or equal to 1.25 but lower than 1.35. The evaluation result “X” (i.e., failed) indicates that the image concentration is lower than 1.25.

Here, the “solid-image-blurring” will be described. If the toner is insufficiently charged or insufficiently supplied to the developing roller 104, the toner layer may not be uniformly formed on the developing roller 104 at the downstream side of the developing blade 107. In such a case, when a solid image is printed on the printing medium 50, the toner may not be sufficiently transferred to the printing medium 50. As a result, the image concentration may become non-uniform or a surface of the printing medium 50 may partially be exposed, particularly at a rear end portion of the solid image in the feeding direction of the printing medium 50. This phenomenon is referred to as a solid-image-blurring. In FIGS. 10 to 14, the solid-image-blurring evaluation result “⊚” indicates that the solid-image-blurring does not occur and the solid image is uniformly printed on the printing medium 50. The solid-image-blurring evaluation result “O” indicates that the surface of the printing medium 50 is not exposed, but the image concentration is lowered at front or rear end portion of the solid image due to slightly insufficient supplying of the toner. The solid-image-blurring evaluation result “X” indicates that the surface of the printing medium 50 is exposed, i.e., white spots (with no toner) are observed.

Next, the “fog” will be described. When the toner is insufficiently charged, there are cases where reversely charged toner adheres to a non-image portion (i.e., a portion other than a latent image) on the surface of the photosensitive drum 101 and is transferred to the printing medium 50, so that image quality is degraded. This phenomenon is referred to as the fog. The evaluation of the fog was performed by observing the surface of the printing medium 50 at 9 positions (i.e., the fog observing positions Au) shown in FIG. 9 using “Digital Microscope VHX-100” (manufactured by Keyence Co., Ltd.) at a magnification of 500. In each position Au, the number to toner dots in a view field of 0.5 mm×0.5 mm was counted. The counted numbers for the 9 positions were averaged so as to give an average counted number.

As shown in FIG. 9, the fog observing positions Au are 9 intersections of three vertical lines VD1, VD2 and VD3 with three horizontal lines HD1, HD2 and HD3. The vertical lines VD1, VD2 and VD3 equally divide a width of the printable area Ap of the printing medium 50 into four parts. The horizontal lines HD1, HD2 and HD3 equally divide a length of the printable area Ap into four parts. Regarding the horizontal lines HD1, HD2 and HD3, the horizontal line HD2 is disposed at a center in the longitudinal direction of the printable area Ap, and the other horizontal lines HD1 and HD3 are disposed at respective centers between the horizontal line HD2 and ends Eh1 and Eh2 of the printable area Ap in the longitudinal direction. Regarding the vertical lines VD1, VD2 and VD3, the vertical line VD2 is disposed at a center in the widthwise direction of the printable area Ap, and the other vertical lines VD1 and VD3 are disposed at respective centers between the vertical line VD2 and ends Ev1 and Ev2 of the printable area Ap in the widthwise direction.

The fog evaluation result “⊚” indicates that the average number of the toner dots is less than or equal to 30. In such a case, the fog is hardly observed on the surface of the printing medium 50, and a satisfactory image can be obtained. The fog evaluation result “O” indicates that the average number of the toner dots is greater than 30 but less than or equal to 60. In such a case, the fog is hardly observed on the surface of a single printing medium 50, but if several printing media 50 (with images formed thereon) are piled, the toners adhering to the respective printing media 50 are overlapped and are seen as being slightly tinted. The fog evaluation result “X” indicates that the average number of toner dots is greater than 60. In such a case, the fog is seen on the surface of the printing medium 50.

The measurement results were as shown in FIGS. 10 to 14.

In Example 1-1 (FIG. 10), the image concentration was 1.35 (and therefore the concentration evaluation result was ⊚), the solid-image-blurring did not occur (i.e., the solid-image-blurring evaluation result was ⊚), and the average number of toner dots was 15 (and therefore the fog evaluation result was ⊚).

### EXAMPLE 1-2

The printing test was performed using the developing blade 107 having the radius R of curvature of 0.15 mm, with other conditions being the same as Example 1-1. As a result of the printing test, the image concentration was 1.37 (and therefore the concentration evaluation result was ⊚), the solid-image-blurring did not occur (i.e., the solid-image-blurring evaluation result was ⊚), and the average number of toner dots was 22 (and therefore the fog evaluation result was ⊚).

### EXAMPLE 1-3

The printing test was performed using the developing blade 107 having the radius R of curvature of 0.18 mm, with other conditions being the same as Example 1-1. As a result of the printing test, the image concentration was 1.38 (and therefore the concentration evaluation result was ⊚), the solid-image-blurring did not occur (i.e., the solid-image-blurring evaluation result was ⊚), and the average number of toner dots was 22 (and therefore the fog evaluation result was ⊚).

### <Comparison 1-1>

The printing test was performed using the developing blade 107 having the radius R of curvature of 0.22 mm, with other conditions being the same as Example 1-1. As a result of the printing test, the image concentration was 1.39 (and therefore the concentration evaluation result was ⊚), and the average number of toner dots was 23 (and therefore the fog evaluation result was ⊚). However, the image blurring occurred on the whole-area solid image, and therefore the solid-image-blurring evaluation result was X.

### EXAMPLES 1-4, 1-5 AND 1-6

The printing tests were performed using the toner T2 instead of the toner T1, and using the developing blades 107 having the radii R of curvatures of 0.13 mm (Example 1-4), 0.15 mm (Example 1-5) and 0.18 mm (Example 1-6) as shown in FIG. 10, with other conditions being the same as Example 1-1. As results of the printing tests, satisfactory images were obtained as shown in FIG. 10.

### EXAMPLES 1-7, 1-8 AND 1-9

The printing tests were performed using the toner T4 instead of the toner T1, and using the developing blades 107 having the radii R of curvatures of 0.13 mm (Example 1-7), 0.15 mm (Example 1-8) and 0.18 mm (Example 1-9) as shown in FIG. 10, with other conditions being the same as Example 1-1. As results of the printing tests, satisfactory images were obtained as shown in FIG. 10.

### <Comparison 1-2>

The printing test was performed using the toner T2 instead of the toner T1, and using the developing blade 107 having the radius R of curvature of 0.22 mm, with other conditions being the same as Example 1-1. As a result of the printing test, the concentration evaluation result was ⊚, and the fog evaluation result was ⊚. However, the image blurring occurred on the whole-area solid image, and therefore the solid-image-blurring evaluation result was X.

### <Comparison 1-3>

The printing test was performed using the toner T4 instead of the toner T1, and using the developing blade 107 having the radius R of curvature of 0.22 mm, with other conditions being the same as Example 1-1. As a result of the printing test, the concentration evaluation result was ⊚, and the fog evaluation result was ⊚. However, the image blurring occurred on the whole-area solid image, and therefore the solid-image-blurring evaluation result was X.

### <Comparisons 1-4 and 1-5>

The printing tests were performed using the toner T5 instead of the toner T1, and using the developing blades 107 having the radii R of curvatures of 0.13 mm (Comparison 1-4) and 0.15 mm (Comparison 1-5) as shown in FIG. 10, with other conditions being the same as Example 1-1. As results of the printing tests, the fog evaluation results were ⊚. However, the image concentrations were low, and the image blurring occurred on the whole-area solid image. Therefore, the concentration evaluation results and the solid-image-blurring evaluation results were both X.

### <Comparisons 1-6 and 1-7>

The printing tests were performed using the toner T5 instead of the toner T1, and using the developing blades 107 having the radii R of curvatures of 0.18 mm (Comparison 1-6) and 0.22 mm (Comparison 1-7) as shown in FIG. 10, with other conditions being the same as Example 1-1. As results of the printing tests, the concentration evaluation results were O, and the fog evaluation results were ⊚. However, the image blurring occurred on the whole-area solid image, and therefore the solid-image-blurring evaluation results were X.

### <Comparisons 1-8 and 1-11>

The printing tests were performed using the toner T3 instead of the toner T1, and using the developing blades 107 having the radii R of curvatures of 0.13 mm (Comparison 1-8), 0.15 mm (Comparison 1-9), 0.18 (Comparison 1-10) and 0.22 mm (Comparison 1-11) as shown in FIG. 10, with other conditions being the same as Example 1-1. As results of the printing tests, the concentration evaluation results were ⊚, and the fog evaluation results were ⊚. However, the image blurring occurred on the whole-area solid image, and therefore the solid-image-blurring evaluation results were X.

These experimental results (using the toner having the mean volume diameter of 3.0 μm) show that, when the bulk density of the toner is low, the supplying amount of the toner is relatively small, and therefore the solid-image-blurring is likely to occur. Meanwhile, the surface area of the toner per unit volume is relatively large, and the toner layer on the developing roller 104 tends to be highly charged, with the result that a rate of the toner adhering to the non-image portion on the photosensitive drum tends to decrease. In contrast, when the bulk density is high, the supplying amount of the toner becomes too large, and the toner tends to be insufficiently charged partially, with the result that the solid-image-blurring is likely to occur partially when the radius R of curvature of the developing blade 107 is large.

### EXAMPLES 1-10, 1-11 AND 1-12

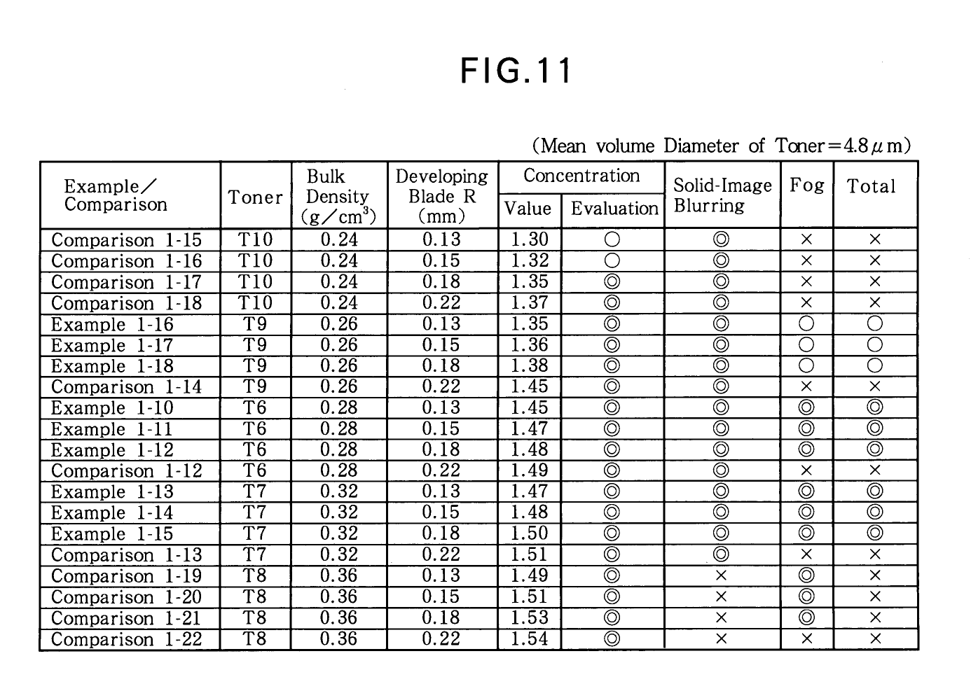

The printing tests were performed using the toner T6 instead of the toner T1, and using the developing blades 107 having the radii R of curvatures of 0.13 mm (Example 1-10), 0.15 mm (Example 1-11) and 0.18 mm (Example 1-12) as shown in FIG. 11, with other conditions being the same as Example 1-1. As results of the printing tests, satisfactory images were obtained as shown in FIG. 11.

### <Comparison 1-12>

The printing test was performed using the toner T6 instead of the toner T1, and using the developing blade 107 having the radius R of curvature of 0.22 mm, with other conditions being the same as Example 1-1. As a result of the printing test, the concentration evaluation result was ⊚, and the solid-image-blurring evaluation result was ⊚ as shown in FIG. 11. However, the average number of toner dots was 79 (therefore the fog evaluation result was X), and image quality was not satisfactory.

### EXAMPLES 1-13, 1-14 AND 1-15

The printing tests were performed using the toner T7 instead of the toner T1, and using the developing blades 107 having the radii R of curvatures of 0.13 mm (Example 1-13), 0.15 mm (Example 1-14) and 0.18 mm (Example 1-15) as shown in FIG. 11, with other conditions being the same as Example 1-1. As results of the printing tests, satisfactory images were obtained as shown in FIG. 11.

### <Comparison 1-13>

The printing test was performed using the toner T7 instead of the toner T1, and using the developing blade 107 having the radius R of curvature of 0.22 mm, with other conditions being the same as Example 1-1. As a result of the printing test, the concentration evaluation result was ⊚, and the solid-image-blurring evaluation result was ⊚ as shown in FIG. 11. However, the average number of toner dots was 70 (therefore the fog evaluation result was X), and the image quality was not satisfactory.

### EXAMPLES 1-16, 1-17 AND 1-18

The printing tests were performed using the toner T9 instead of the toner T1, and using the developing blades 107 having the radii R of curvatures of 0.13 mm (Example 1-16), 0.15 mm (Example 1-17) and 0.18 mm (Example 1-18) as shown in FIG. 11, with other conditions being the same as Example 1-1. As results of the printing tests, satisfactory images were obtained as shown in FIG. 11.

### <Comparison 1-14>

The printing test was performed using the toner T9 instead of the toner T1, and using the developing blade 107 having the radius R of curvature of 0.22 mm, with other conditions being the same as Example 1-1. As a result of the printing test, the concentration evaluation result was ⊚, and the solid-image-blurring evaluation result was ⊚ as shown in FIG. 11. However, the average number of toner dots was 85 (therefore the fog evaluation result was X), and image quality was not satisfactory.

### <Comparisons 1-15, 1-16, 1-17 and 1-18>

The printing tests were performed using the toner T10 instead of the toner T1, and using the developing blades 107 having the radii R of curvatures of 0.13 mm (Comparison 1-15), 0.15 mm (Comparison 1-16), 0.18 mm (Comparison 1-17) and 0.22 mm (Comparison 1-18), with other conditions being the same as Example 1-1. As results of the printing tests, the concentration evaluation results were ⊚, and the solid-image-blurring evaluation results were ⊚ as shown in FIG. 11. However, the fog evaluation results were X, and image qualities were not satisfactory.

### <Comparisons 1-19, 1-20, 1-21 and 1-22>

The printing tests were performed using the toner T8 instead of the toner T1, and using the developing blades 107 having the radii R of curvatures of 0.13 mm (Comparison 1-19), 0.15 mm (Comparison 1-20), 0.18 mm (Comparison 1-21) and 0.22 mm (Comparison 1-22), with other conditions being the same as Example 1-1. As results of the printing tests, the solid-image-blurring evaluation results were X as shown in FIG. 11, and image qualities were not satisfactory.

These experimental results show that, in the case where the mean volume diameter of the toner is 4.8 μm, the thickness of the toner layer tends to be thick for the same bulk density, so that the image concentration tends to be high, and the solid-image-blurring is less likely to occur compared with the case where the mean volume diameter of the toner is 3.0 μm. As the particle diameter of the toner increases, the surface area of the toner per unit area decreases, and the electric charge of the toner layer on the developing roller 104 becomes relatively low, with the result that the rate of the toner adhering to the non-image portion on the photosensitive drum 101 increases. However, when the radius R of curvature of the developing blade 107 is reduced, the toner strongly adheres to the developing blade 107, and the rate of the toner adhering to the non-image portion on the photosensitive drum 101 can be reduced. Meanwhile, when the bulk density is high, and when the radius R of curvature of the developing blade 107 is relatively large, the supplying amount of the toner becomes too large, and the toner may be insufficiently charged partially, so that the solid-image-blurring may occur partially.

### EXAMPLES 1-19 TO 1-27, AND COMPARISONS 1-23 TO 1-33

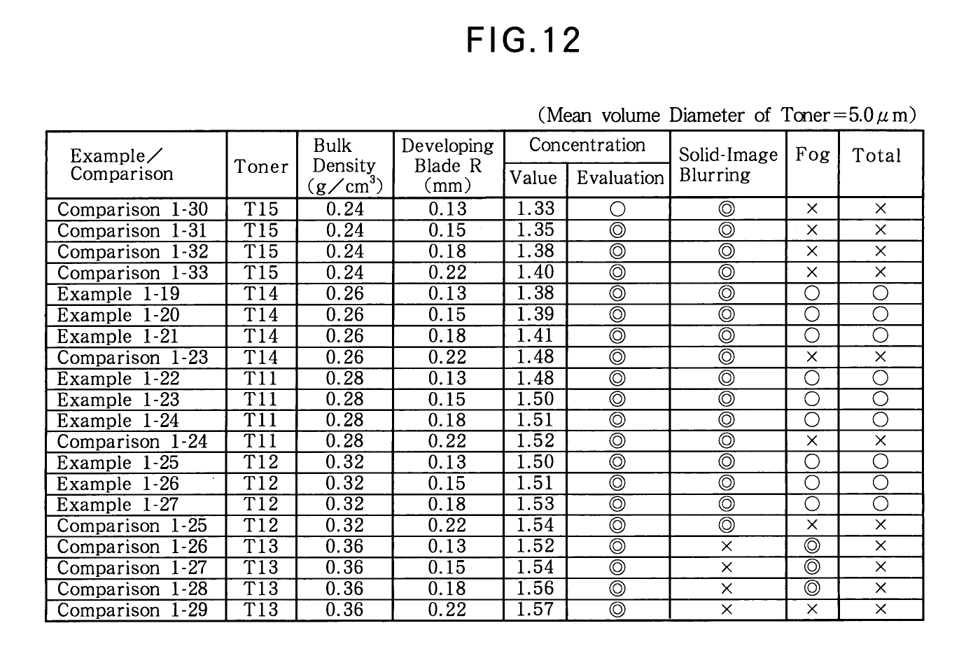

The printing tests were performed using the toner T14 (Examples 1-19 to 1-21), the toner T11 (Examples 1-22 to 1-24) and the toner T12 (Examples 1-25 to 1-27) instead of the toner T1, and using the developing blades 107 having the radii R of curvature of 0.13 mm (Examples 1-19, 1-22, 1-25), 0.15 mm (Examples 1-20, 1-23, 1-26) and 0.18 mm (Examples 1-21, 1-24, 1-27) as shown in FIG. 12, with other conditions being the same as Example 1-1.

Further, the printing tests were performed using the toner T14 (Comparison 1-23), the toner T11 (Comparison 1-24), the toner T12 (Comparison 1-25), the toner T13 (Comparisons 1-26 to 1-29) and the toner T15 (Comparisons 1-30 to 1-33) instead of the toner T1, and using the developing blades 107 having radii R of curvature of 0.13 mm (Comparisons 1-26, 1-30), 0.15 mm (Comparisons 1-27, 1-31), 0.18 mm (Comparisons 1-28, 1-32), 0.22 (Comparisons 1-23, 1-24, 1-25, 1-29, 1-33) as shown in FIG. 12, with other conditions being the same as Example 1-1. The toners T11 to T15 have the mean volume diameter of 5.0 μm.

The experimental results shown in FIG. 12 are almost the same as those shown in FIG. 11 where the toner has the mean volume diameter of 4.8 μm. However, the occurrence of the fog (Comparisons 1-23 to 1-33) slightly increases compared with Comparisons 1-16 to 1-22. It is conceivable that, as the particle diameter of the toner becomes slightly larger, the surface area of the toner per unit volume slightly decreases, and the electric charge of the toner layer on the developing roller becomes relatively small, with the result that the rate of the toner adhering to the non-image portion on the photosensitive drum 101 slightly increases.

### <Comparisons 1-34 to 1-53>

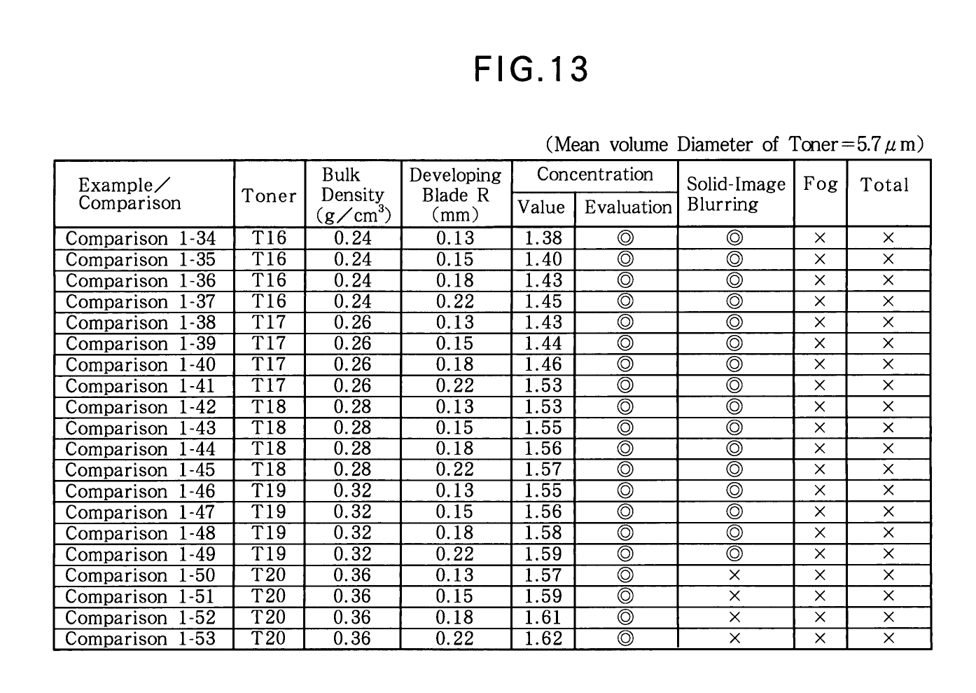

The printing tests were performed using the toner T16 (Comparisons 1-34 to 1-37), the toner T17 (Comparisons 1-38 to 1-41), the toner T18 (Comparison 1-42 to 1-45), the toner T19 (Comparisons 1-46 to 1-49) and the toner T20 (Comparisons 1-50 to 1-53) instead of the toner T1, and using the developing blades 107 having the radii R of curvature of 0.13 mm (Comparisons 1-34, 1-38, 1-42, 1-46, 1-50), 0.15 mm (Comparisons 1-35, 1-39, 1-43, 1-47, 1-51), 0.18 mm (Comparisons 1-36, 1-40, 1-44, 1-48, 1-52), 0.22 (Comparisons 1-37, 1-41, 1-45, 1-49, 1-53) as shown in FIG. 13, with other conditions being the same as Example 1-1. The toners T16 to T20 have the mean volume diameter of 5.7 μm.

As results of the printing tests, the occurrence of fog increased, and image quality was not satisfactory as shown in FIG. 13. It is conceivable that, since the particle diameter of the toner becomes larger, the surface area of the toner per unit volume decreases, and the electric charge of the toner layer on the developing roller becomes relatively small, with the result that the rate of the toner adhering to the non-image portion on the photosensitive drum 101 increases.

### <Comparisons 1-54 to 1-73>

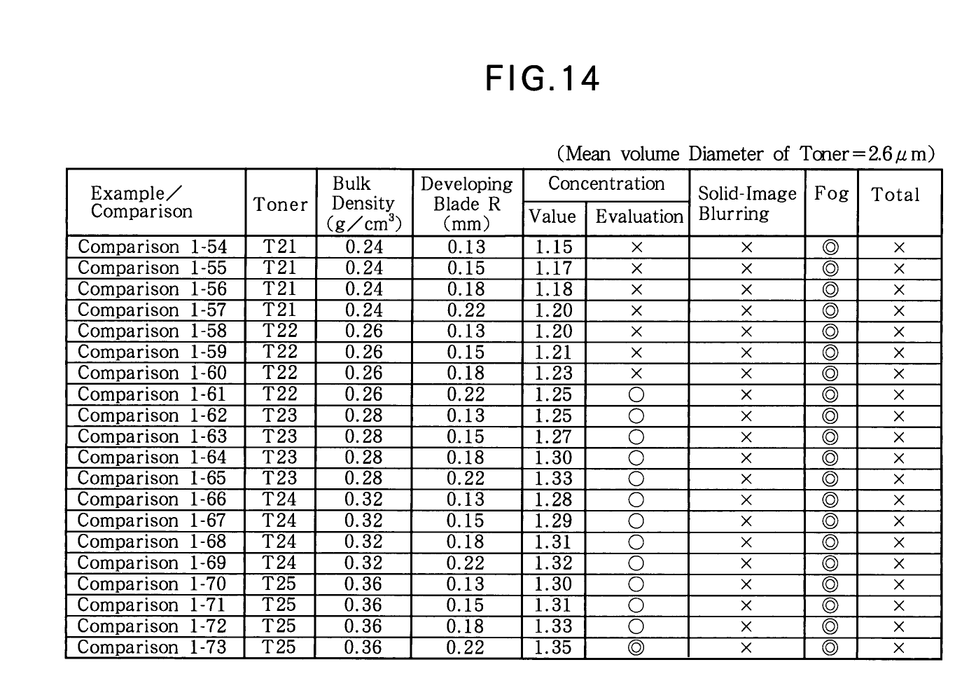

The printing tests were performed using the toner T21 (Comparisons 1-54 to 1-57), the toner T22 (Comparisons 1-58 to 1-61), the toner T23 (Comparison 1-62 to 1-65), the toner T24 (Comparisons 1-66 to 1-69) and the toner T25 (Comparisons 1-70 to 1-73) instead of the toner T1, and using the developing blades 107 having the radii R of curvature of 0.13 mm (Comparisons 1-54, 1-58, 1-62, 1-66, 1-70), 0.15 mm (Comparisons 1-55, 1-59, 1-63, 1-67, 1-71), 0.18 mm (Comparisons 1-56, 1-60, 1-64, 1-68, 1-72), 0.22 (Comparisons 1-57, 1-61, 1-65, 1-69, 1-73) as shown in FIG. 14, with other conditions being the same as Example 1-1. The toners T21 to T25 have the mean volume diameter of 2.6 μm.

As results of the printing tests, the solid-image-blurring occurs, and satisfactory image is not obtained as shown in FIG. 14. It is conceivable that, since the particle diameter of the toner is small, the thickness of the toner layer on the developing roller becomes thin, with the result that the solid-image-blurring occurs.

Here, advantages of the first embodiment of the present invention will be described.

In a general printer, when the printing speed of the printer increases, the toner in the toner reserving portion (for example, the toner hopper 140) may be used to develop the latent image before the toner reaches a saturation bulk density. Therefore, it is difficult to obtain stable toner developing property, and it is difficult to obtain satisfactory image quality even when the saturation bulk density of the toner is defined.

However, according to the first embodiment of the present invention, as will be appreciated from the above described experimental results, the toner developing property can be stabilized (i.e., the sufficient image concentration can be obtained), and the image blurring and fog can be prevented in the case where:

(1) the mean volume diameter of the toner is in a range from 3.0 to 5.0 μm,

(2) the bulk density of the toner is in a range from 0.26 to 0.32 g/cm³, and

(3) the radius R of curvature of the curved portion 703 of the developing blade 107 is less than or equal to 0.18 mm.

In such a case, satisfactory image quality with enhanced graininess can be obtained.

Preferably, more satisfactory image quality can be obtained in the case where:

(1)′ the mean volume diameter of the toner is in a range from 3.0 to 4.8 μm, and

(2)′ the bulk density of the toner is in a range from 0.28 to 0.32 g/cm³.

### Second Embodiment

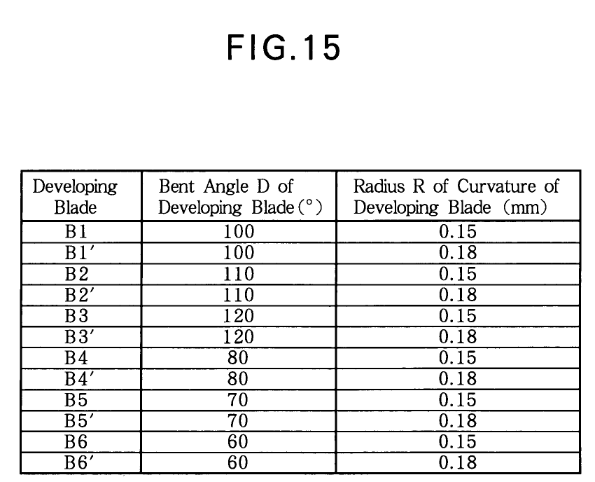

The second embodiment of the present invention is different from the first embodiment in the bent angle D of the developing blade 107. In this embodiment, for example, developing blades B1, B2, B3, B4, B5 and B6 having bent angles D of 100°, 110°, 120°, 80°, 70° and 60° are used as shown in FIG. 15. The developing blades B1, B2, B3, B4, B5 and B6 have the same radii R of curvature (0.15 mm). Further, the developing blades B1′, B2′, B3′, B4′, B5′ and B6′ are used, which are respectively the same as the developing blades B1, B2, B3, B4, B5 and B6 except that the developing blades B1′, B2′, B3′, B4′, B5′ and B6′ have radii R of curvature of 0.18 mm.

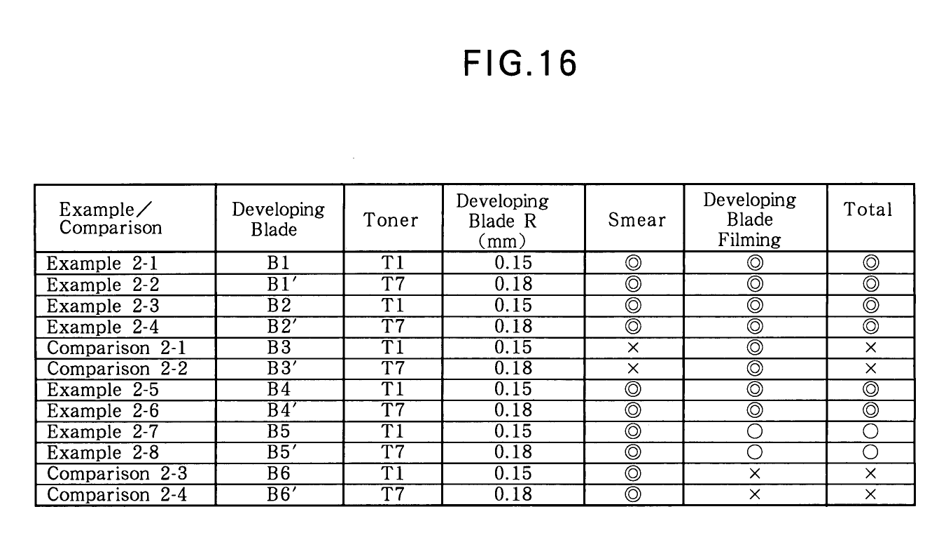

Using the developing blades B1 to B6 and B1′ to B6′, the printing tests were performed. Then, a smear and a filming on the developing blade 107 were checked. The results are shown in FIG. 16.

FIG. 16 shows evaluation results of a smear or stripes on the printed image (“smear evaluation”). In this regard, the smear occurs when the thickness of the toner layer on the developing roller 104 partially increases. In such a case, the toner on the developing roller 104 adheres to the photosensitive drum 101 regardless of the latent image, and is transferred to the printing medium so as to form stripes of the toner. That is, the stripes of the toner (i.e., the smear) are printed on the surface of the printing medium 50. The smear evaluation result “X” indicates that the smear is found on the surface of the printing medium 50. The smear evaluation result “O” indicates that the smear is hardly found on the surface of the printing medium 50. The smear evaluation result “⊚” indicates that the smear is not found on the surface of the printing medium 50.

FIG. 16 also shows evaluation results of the filming on the developing blade 107, more specifically, results of checking whether a fusion-bonding of the toner onto the curved portion 703 of the developing blade 107 occurs or not.

In this regard, when the curved portion 703 of the developing blade 107 is pressed against the developing roller 104 with a high pressure, the fusion-bonding of the toner onto the developing blade 107 occurs so as to form a film. Such a film prevents the formation of the toner layer on the developing roller 104, and causes white stripes to be formed. Such a phenomenon is referred to as “developing blade filming”. The developing blade filming evaluation result “X” indicates that the fusion-bonding of the toner onto the developing blade 107 occurs. The developing blade filming evaluation result “O” indicates that the fusion-bonding of the toner onto the developing blade 107 hardly occurs. The developing blade filming evaluation result “⊚” indicates that the fusion-bonding of the toner onto the developing blade 107 does not occur.

### EXAMPLE 2-1

The printing test was performed using the cleaning blade B1 having the bent angle D of 100°, with other conditions being the same as Example 1-2. Then, the smear or stripes on the printed image was checked. As a result, the smear or stripes was not found on the printed image, and the satisfactory image was obtained. Therefore, the smear evaluation result was ⊚. Then, the developing blade B1 is taken out of the printer 10, and the curved portion 703 of the developing roller 107 is observed using “Digital Microscope VHX-100” (manufactured by Keyence Co. Ltd.) at a magnification of 500. As a result, the fusion-bonding of the toner is not observed, and therefore the developing blade filming evaluation result was ⊚.

### EXAMPLE 2-2

The printing test was performed using the toner T7 instead of the toner T1 and using the cleaning blade B1′ having the bent angle D of 100° and the radius R of curvature of 0.18 mm, with other conditions being the same as Example 2-1. As a result of the printing test, the smear or stripes was not found on the printed image, and the fusion-bonding of the toner is not observed via the digital microscope. That is, satisfactory image was obtained. Therefore, the smear evaluation result and the developing blade filming evaluation result were both ⊚.

### EXAMPLE 2-3

The printing test was performed using the developing blade B2 having the bent angle D of 110°, with other conditions being the same as Example 2-1. As a result of the printing test, the smear or stripes was not found on the printed image, and the fusion-bonding of the toner is not observed via the digital microscope. That is, satisfactory image was obtained. Therefore, the smear evaluation result and the developing blade filming evaluation result were both ⊚.

### EXAMPLE 2-4

The printing test was performed using the toner T7 instead of the toner T1 and using the developing blade B2′ having the bent angle D of 110° and the radius R of curvature of 0.18 mm, with other conditions being the same as Example 2-1. As a result of the printing test, the smear or stripes was not found on the printed image, and the fusion-bonding of the toner was not observed via the digital microscope. That is, satisfactory image was obtained. Therefore, the smear evaluation result and the developing blade filming evaluation result were both ⊚.

### <Comparison 2-1>

The printing test was performed using the developing blade B3 having the bent angle D of 120°, with other conditions being the same as Example 2-1. As a result of the printing test, the smear was found on the printed image. Therefore the smear evaluation result was X. It is conceivable that, when the bent angle D is large, a pressure with which the developing blade 107 regulates the thickness of the toner layer is weakened, and the thickness of the toner layer may partially increase. The white stripes (with no toner) were not found. Further, the fusion-bonding of the toner onto the curved portion 703 of the developing roller 107 was not observed via the digital microscope. Therefore, the developing blade filming evaluation result was ⊚.

### <Comparison 2-2>

The printing test was performed using the toner T7 instead of the toner T3, and using the developing blade B3′ having the bent angle D of 120° and the radius R of curvature of 0.18 mm, with other conditions being the same as Example 2-1. As a result of the printing test, the smear was found on the printed image, as is the case with Comparison 2-1. Therefore, the smear evaluation result was X. The white stripes (having no toner) were not found. Further, the fusion-bonding of the toner onto the curved portion 703 of the developing roller 107 was not observed by the digital microscope. Therefore, the developing blade filming evaluation result was ⊚.

### EXAMPLE 2-5

The printing test was performed using the developing blade B4 having the bent angle D of 80°, with other conditions being the same as Example 2-1. As a result of the printing test, the smear or stripes was not found on the printed image, and the fusion-bonding of the toner was not observed by the digital microscope. In other words, satisfactory printed image was obtained. Therefore, the smear evaluation result and the developing blade filming evaluation result were both ⊚.

### EXAMPLE 2-6

The printing test was performed using the toner T7 instead of the toner T1, and using the developing blade B4′ having the bent angle D of 80° and the radius of curvature of 0.18 mm, with other conditions being the same as Example 2-1. As a result of the printing test, the smear or stripes was not found on the printed image, and the fusion-bonding of the toner was not observed by the digital microscope. In other words, satisfactory printed image was obtained. Therefore, the smear evaluation result and the developing blade filming evaluation result were both ⊚.

### EXAMPLE 2-7

The printing test was performed using the developing blade B5 having the bent angle D of 70°, with other conditions being the same as Example 2-1. As a result of the printing test, the smear or stripes was not found on the printed image, and satisfactory printed image was obtained. Therefore, the smear evaluation result was However, a minute fusion-bonding of the toner onto the curved portion 703 of the developing blade 107 was observed by the digital microscope. The fusion-bonding of the toner is minute, and the printed image is not affected. Therefore, the developing blade filming evaluation result was O.

### EXAMPLE 2-8

The printing test was performed using the toner T7 instead of the toner T1 and using the developing blade B5′ having the bent angle D of 70° and the radius R of curvature of 0.18 mm, with other conditions being the same as Example 2-1. As a result of the printing test, the smear or stripes was not found on the printed image, and satisfactory printed image was obtained. Therefore, the smear evaluation result was ⊚. However, minute fusion-bonding of the toner onto the curved portion 703 of the developing blade 107 was observed by the digital microscope. The fusion-bonding of the toner is minute, and the printed image is not affected. Therefore, the developing blade filming evaluation result was O.

### <Comparison 2-3>

The printing test was performed using the developing blade B6 having the bent angle D of 60°, with other conditions being the same as Example 2-1. As a result of the printing test, the smear was not found on the printed image, and therefore the smear evaluation result was ⊚. However, the white stripes with no toner (through which the surface of the printing medium 50 is exposed) were found on the printed image in parallel to the feeding direction of the printed medium 50. Further, the fusion-bonding of the toner onto the curved portion 703 of the developing roller 107 was observed via the digital microscope. The reason thereof is considered as follows. When the radius R of curvature of the curved portion 703 of the developing blade 107 is small, the toner particles are applied with increasing pressure and subject to friction heat, so that the toner is partially fusion-bonded to the developing blade 107. The formation of the toner layer is prevented at a portion where the toner is fixed to the developing blade 107, so that white stripes are formed on the printed image. Therefore, the developing blade filming evaluation result was X.

### <Comparison 2-4>

The printing test was performed using the toner T7 instead of the toner T1 and using the developing blade B6′ having the bent angle D of 60° and the radius R of curvature of 0.18 mm, with other conditions being the same as Example 2-1. As a result of the printing test, the smear was not found on the printed image, and therefore the smear evaluation result was ⊚. However, the white stripes with no toner (through which the surface of the printing medium 50 is exposed) were found on the printed image in parallel to the feeding direction of the printed medium 50. Further, the fusion-bonding of the toner onto the curved portion 703 of the developing roller 107 was observed via the digital microscope. The reason thereof is considered as follows. When the radius R of curvature of the curved portion 703 of the developing blade 107 is small, the toner particles are applied with increasing pressure and subject to friction heat, so that the toner is partially fusion-bonded to the developing blade 107. The formation of the toner layer is prevented at a portion where the toner is fusion-bonded to the developing blade 107, so that white stripes are formed on the printed image. Therefore, the developing blade filming evaluation result was X.

From these results, it is understood that a satisfactory image (without smear or stripes) can be obtained by setting the bent angle D of the curved portion 703 of the developing blade 107 in a range from 70 to 110°. Further, it is understood that a more satisfactory image can be obtained by setting the bent angle D of the curved portion 703 of the developing blade 107 in a range from 80 to 110°.

### <Rotation Speed of Agitating Member>

In the above described Examples 1-1 to 1-27 and 2-1 to 2-8, the circumferential speed of the agitation shaft 145 is set to 200 mm/sec as described above.

Further printing tests were performed while varying the circumferential speed of the agitation shaft 145 within a range from 150 mm/sec to 300 mm/sec, although detailed descriptions thereof are omitted. As results of the printing tests, satisfactory images were obtained.

In this regard, when the circumferential speed of the agitation shaft 145 is higher than 300 mm/sec, the agitation shaft 145 does not sufficiently agitate the toner in the toner hopper 140. Further, when the circumferential speed of the agitation shaft 145 is lower than 150 mm/sec, the toner in the toner hopper 140 is applied with a stress and may be damaged. For these reasons, the printing test was not performed for the circumferential speed higher than 150 mm/sec and lower than 300 mm/sec.

In the above described embodiments, the image forming apparatus has been described as the printer 10. However, the present invention is not limited to a printer, but can be applicable to, for example, a facsimile apparatus, a copier, an MFP (Multiple Function Peripherals) or the like.

While the preferred embodiments of the present invention have been illustrated in detail, it should be apparent that modifications and improvements may be made to the invention without departing from the spirit and scope of the invention as described in the following claims.

What is claimed is:

1. An image forming unit comprising:
a developer bearing body that supplies a developer to an image bearing body that bears a latent image, and
a developer layer forming member that forms a layer of said developer on said developer bearing body,
wherein said developer has a mean volume diameter in a range from 3.0 to 5.0 μm and a bulk density in a range from 0.26 to 0.32 g/cm³, and
wherein said developer layer forming member has a curved portion having a radius of curvature smaller than or equal to 0.18 mm and constituting a developer layer forming portion.

2. The image forming unit according to claim 1, wherein an angle between a tangential plane at an end of said curved portion and another tangential plane at another end of said curved portion is in a range from 70 to 110°.

3. The image forming unit according to claim 1, further comprising a developer reserving portion for reserving said developer, and an agitating member disposed in said developer reserving portion for agitating said developer.

4. The image forming unit according to claim 3, wherein said agitating member rotates at a circumferential speed in a range from 150 to 300 mm/sec.

5. The image forming unit according to claim 1, wherein said developer contains toner mother particles and external additives added to said toner mother particles.

6. The image forming unit according to claim 5, wherein said developer has a circularity in a range from 0.930 to 0.955.

7. The image forming unit according to claim 1, wherein said developer layer forming member is in the form of a blade.

8. The image forming unit according to claim 1, wherein an end of said developer layer forming member is a fixed end, and the other end of said developer layer forming member is a free end, and
wherein said free end faces said developer bearing body.

9. An image forming apparatus comprising:
said image forming unit according to claim 1.
